(19) United States
(12) Patent Application Publication
(10) Pub. No.: US 2023/0230785 A1
(43) Pub. Date: Jul. 20, 2023

(54) Load Break Switch

(71) Applicant: ABB Schweiz AG, Baden (CH)

(72) Inventors: Maik Hyrenbach, Ratingen (DE); Sebastian Breisch, Neckarsteinach (DE); Ondrej Frantisek, Heddesheim (DE)

(73) Assignee: ABB Schweiz AG, Baden (CH)

(21) Appl. No.: 18/187,778

(22) Filed: Mar. 22, 2023

Related U.S. Application Data
(63) Continuation of application No. PCT/EP2021/073998, filed on Aug. 31, 2021.

(30) Foreign Application Priority Data
Sep. 23, 2020 (EP) 20197881.4

(51) Int. Cl. H01H 33/664; H01H 33/666

(52) U.S. Cl. CPC H01H 33/664; H01H 33/666

(57) ABSTRACT

A medium voltage load break switch includes a main contact and a knife. The knife is rotatable about a pivot point to connect to and be in contact with the main contact and to rotate about the pivot point to disconnect from and be spaced from the main contact. The load break switch also comprises a vacuum interrupter that has a fixed contact and a moveable contact. A lever rotates about a rotation point and a shaft of the moveable contact is aligned along an axis of the vacuum interrupter, and the shaft of the moveable contact is linked to the lever.

### CROSS-REFERENCE TO RELATED APPLICATIONS

This patent application claims priority to International Patent Application No. PCT/EP2021/073998, filed on Aug. 31, 2021, and to European Patent Application No. 20197881.4, filed on Sep. 23, 2020, each of which is incorporated herein in its entirety by reference.

### FIELD OF THE DISCLOSURE

The present disclosure relates to a medium voltage load break switch and to a medium voltage switchgear that comprises such a load break switch.

### BACKGROUND OF THE INVENTION

Vacuum interrupters (VIs), can be used as part of a load break switch, but existing solutions have different disadvantages.

There is a need to address these problems.

### BRIEF SUMMARY OF THE INVENTION

Therefore, it would be advantageous to have an improved load break switch.

In a first aspect, there is provided a medium voltage load break switch. The load break switch comprises a main contact and a knife. The knife is configured to rotate about a pivot point to connect to and be in contact with the main contact and to rotate about the pivot point to disconnect from and be spaced from the main contact. The load break switch also comprises a vacuum interrupter. The vacuum interrupter has a fixed contact and a moveable contact that are in a housing of the vacuum interrupter. The main contact is in electrical connection with the fixed contact of the vacuum interrupter. The load break switch also has a lever. The lever is configured to rotate about a rotation point of the lever. The main contact is spaced from the lever. A shaft of the moveable contact is aligned along an axis of the vacuum interrupter, and the shaft of the moveable contact is linked to the lever. In a closed configuration of the load break switch the knife is in contact with the main contact and spaced from the lever.

In a closed configuration the lever is at a first rotational orientation and the rotation point of the lever is at a first distance from the fixed contact measured in a direction parallel to the axis of the vacuum interrupter and the moveable contact is in contact with the fixed contact, and current can flow through the main contact directly to the knife. Rotation of the knife about its pivot point in a first rotational direction transitions the switch from the closed configuration to a commutation configuration. In the commutation configuration the knife is in contact with the lever and in contact with the main contact, and current can flow through the main contact directly to the knife and flow through the main contact and through the vacuum interrupter to the knife. Rotation of the knife about its pivot point in the first rotational direction transitions the switch from the commutation configuration to an opened configuration. In the opened configuration the knife is spaced from the main contact and spaced from the lever or in contact with the lever. In the opened configuration the lever is in a second rotational orientation and the rotation point of the lever is at a second distance from the fixed contact measured in the direction parallel to the axis of the vacuum interrupter that is greater than the first distance and the moveable contact is spaced from the fixed contact.

Here parallel to the axis means a direction that can be along the axis or slightly to the side of the axis, but in the direction of the axis. Thus the rotation point of the lever can move along the axis or move to the side of the axis, but in a direction of the axis, and both of these situations relate to a direction parallel to the axis. Indeed, a global movement of the rotation point of the lever can also be angled to the axis, but still have a component parallel to the axis, and thus there is still a component that is in a direction parallel to the axis. Thus, a curved movement of the rotation point of the lever also has a component in a direction parallel to the axis.

### BRIEF DESCRIPTION OF THE SEVERAL VIEWS OF THE DRAWING(S)

FIGS. 1a and 1b show an example of the new vacuum interrupter in closed and open positions respectively, showing the new design of a bi-stable L shaped lever used to drive the opening and closing operations of the vacuum interrupter in accordance with the disclosure.

FIGS. 2a and 2b show an example of the vacuum of FIGS. 1a-b as a shunt circuit vacuum interrupter in a load break switch in accordance with the disclosure.

FIGS. 3a, 3b, 3c, 3d, and 3e show an example of the operating sequences of the load break switch of FIG. 2 in breaking a current path connection.

FIGS. 4a, 4b, 4c, and 4d show examples of the operating sequences of the load break switch of FIGS. 2a and 2b, in making a current path connection.

### DETAILED DESCRIPTION OF THE INVENTION

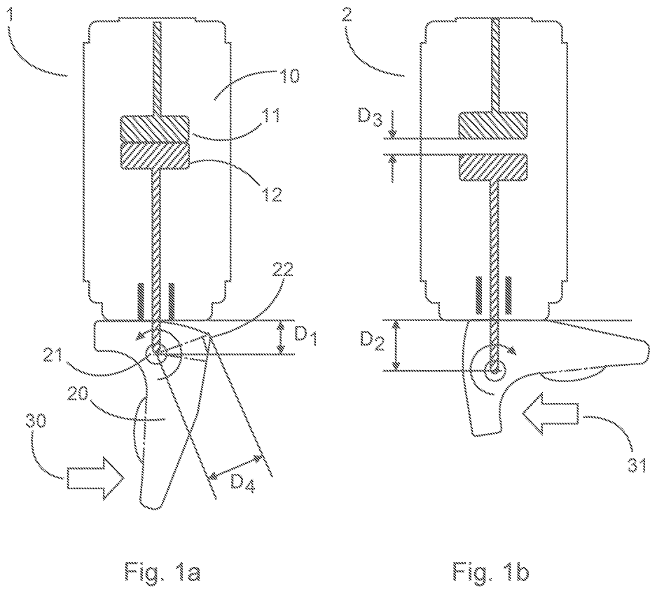

FIGS. 1a, 1b, 2a, 2b, 3a, 3b, 3c, 3d, 3e, 4a, 4b, 4c, and 4d, relate to a new design of load break switch that can be used in a medium voltage switchgear.

An example of the new load break switch comprises a main contact and a knife. The knife is configured to rotate about a pivot point to connect to and be in contact with the main contact and to rotate about the pivot point to disconnect from and be spaced from the main contact. The load break switch also comprises a vacuum interrupter 10. The vacuum interrupter has a fixed contact 11 and a moveable contact 12 that are in a housing of the vacuum interrupter. The main contact is in electrical connection with the fixed contact of the vacuum interrupter. The load break switch also has a lever 20. The lever is configured to rotate about a rotation point 21 of the lever. The main contact is spaced from the lever. A shaft of the moveable contact is aligned along an axis of the vacuum interrupter, and the shaft of the moveable contact is linked to the lever. In a closed configuration of the load break switch the knife is in contact with the main contact and spaced from the lever. In a closed configuration the lever is at a first rotational orientation and the rotation point of the lever is at a first distance from the fixed contact measured in a direction parallel to the axis of the vacuum interrupter and the moveable contact is in contact with the fixed contact, and current can flow through the main contact directly to the knife. Rotation of the knife about its pivot point in a first rotational direction transitions the switch from the closed configuration to a commutation configuration.

In the commutation configuration the knife is in contact with the lever and in contact with the main contact, and current can flow through the main contact directly to the knife and flow through the main contact and through the vacuum interrupter to the knife. Rotation of the knife about its pivot point in the first rotational direction transitions the switch from the commutation configuration to an opened configuration. In the opened configuration the knife is spaced from the main contact and spaced from the lever or in contact with the lever—in general the knife will have continued to rotate to not be in contact with the lever and this is the ideal situation. However, because the contacts of the VI are open no current can flow and therefore the knife can be in contact with the lever. In the opened configuration the lever is in a second rotational orientation and the rotation point of the lever is at a second distance from the fixed contact measured in the direction parallel to the axis of the vacuum interrupter that is greater than the first distance and the moveable contact is spaced from the fixed contact.

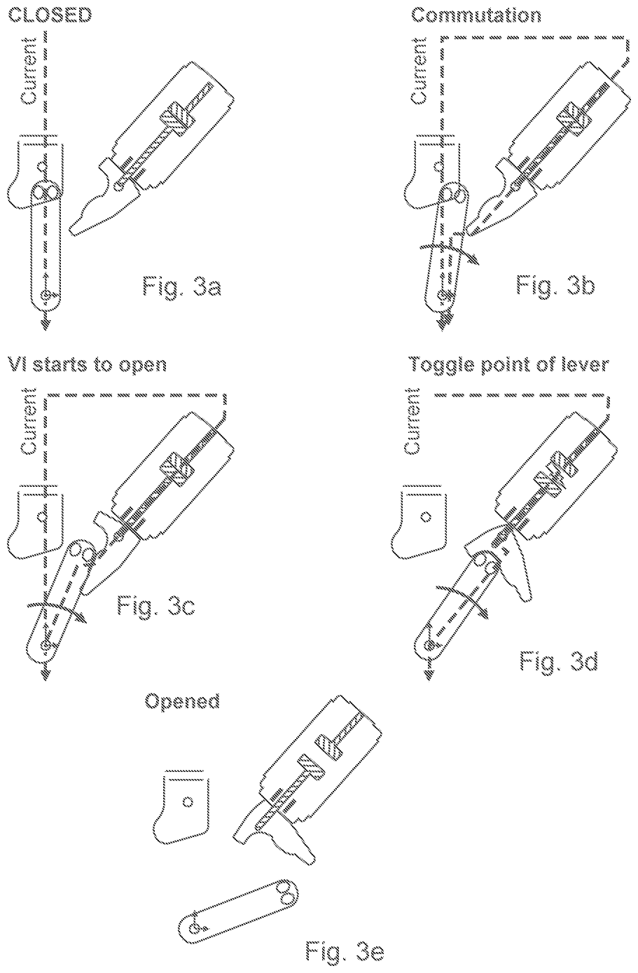

The closed configuration is shown in FIG. 3a labelled as closed, where the lever is in its first rotational orientation as shown in the left hand drawing of FIG. 1a. The commutation configuration is shown in FIG. 3b and labelled as commutation. The lever can be in the first rotational orientation as shown in the left hand drawing of FIG. 1a or can have rotated slightly, but the contacts of the vacuum interrupter are in contact. Thus, here current has two flow routes from the main contact to the knife, a direct one and an indirect one via the vacuum interrupter. The opened configuration is shown in FIG. 3e and labelled as opened. In this figure the knife is shown not contacting the lever, but it can do so as the vacuum interrupter is open. The lever is in its second rotational orientation as shown in the right hand drawing of FIG. 1b.

In an example, the shaft of the moveable contact is linked to the lever such that a movement of the rotation point of the lever in the direction parallel to the axis of the vacuum interrupter results in an equivalent movement of the moveable contact along the axis of the vacuum interrupter.

In an example, the switch is configured such that in the closed configuration the first rotational orientation of the lever is a stable position.

In an example, the switch is configured such that in the opened configuration the second rotational orientation of the lever is a stable position.

In an example, rotation of the knife about its pivot point in the first rotational direction transitions the switch from the commutation configuration to a toggle point configuration. In the toggle point configuration the knife is spaced from the main contact and in contact with the lever. In the toggle point configuration the lever is in a third rotational orientation and the rotation point of the lever is at a third distance from the fixed contact measured in the direction parallel to the axis of the vacuum interrupter that is greater than the second distance and the moveable contact is spaced from the fixed contact.

In an example, a first force 30 applied to a first part of the lever by the knife transitions the switch from the closed configuration to the toggle point configuration.

In an example, the switch is configured such that no force is required to be applied to the first part of the lever to transition the switch from the toggle point configuration to the opened configuration.

In an example, rotation of the knife about its pivot point in the first rotational direction transitions the switch from the commutation configuration to a transition point configuration. In the transition point configuration the knife is spaced from the main contact and in contact with the lever. In the transition point configuration the moveable contact is in contact with the fixed contact, and current can flow through the main contact and through the vacuum interrupter to the knife. A further rotation leads to the contacts beginning to open.

In an example, rotation of the knife about its pivot point in a second rotational direction opposite to the first rotational direction transitions the switch from the opened configuration to the closed configuration.

In an example, rotation of the knife about its pivot point in the second rotational direction transitions the switch from the opened configuration to the toggle point configuration.

In an example, a second force 31 applied to a second part of the lever is configured to transition the lever from the opened configuration to the closed configuration.

In an example, the switch is configured such that no force is required to be applied to the second part of the lever to transition the switch from the toggle point configuration to the closed configuration.

In an example, the switch comprises a spring configured to push the lever in the direction parallel to the axis of the vacuum interrupter toward the fixed contact.

The new load break switch is now described in specific detail with respect to a detailed embodiment, where again reference is made to the figures.

FIG. 1a shows at 1 the vacuum interrupter (VI) 10 in the closed position, with closed contacts 11, 12. Contact 11 is a fixed contact and contact 12 is a moveable contact. The L shape lever 20 is positioned in the first stable position, keeping the rotating point of the lever 21 a distance of D1 from the operating surface on the VI. The lever at this point is in its first rotational orientation as described above. To compensate tolerances between the position of the contacts in the closed position and of the lever, a small spring is pushing the L-shape lever in a defined closed position. With a force supplied on the lever as indicated in 30, the lever is forced to rotate, until the toggle point 22, where the distance D4 between the rotating point 30 and the surface is the largest. The lever at this point is in its third rotational orientation as described above, and between the first rotational position and the third rotational position the lever is at a rotational position. At this rotational position the contacts 11 and 12 are still in contact for current to still pass through the VI. Thus at this rotational position the switch is in its transition configuration. Then as the lever continues to rotate towards the third rotational position the contacts start to open and current is interrupted before the third rotational position is reached. Due to the force of the vacuum against the higher ambient pressure outside the VI, after the third rotational orientation the lever continues its rotation until the second stable position is reached shown in FIG. 1b as 2, where the VI is in the open position. The lever at this point is in its second rotational orientation as described above. Thus, as detailed above the third rotational orientation is between the first and second rotational orientations. The contact opening distance D3 is kept by the increased thickness of this side of the lever means the higher distance D2 between the rotating point of the lever 21 and the surface. For closing the VI, a force needs to be applied 31 until the toggle point is passed from the other rotational direction, then the VI will close the contacts due to the forces of the gas pressure outside the VI.

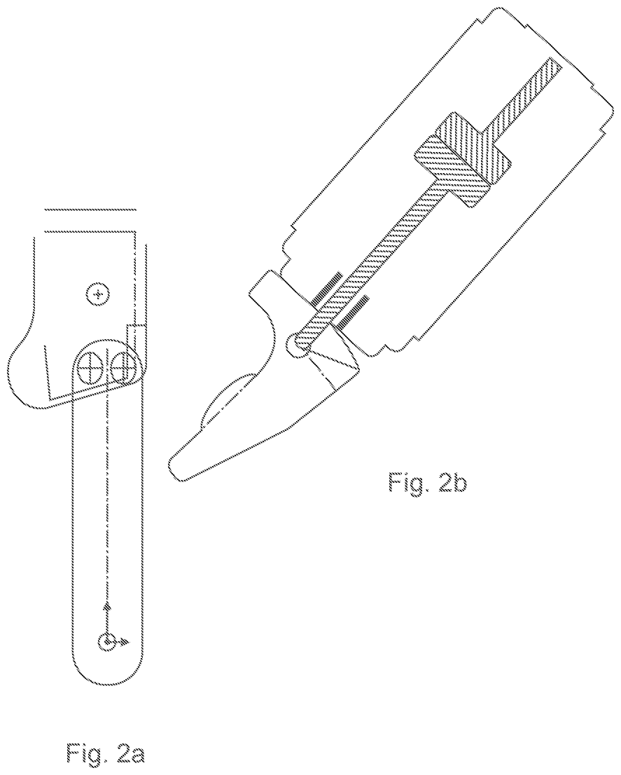

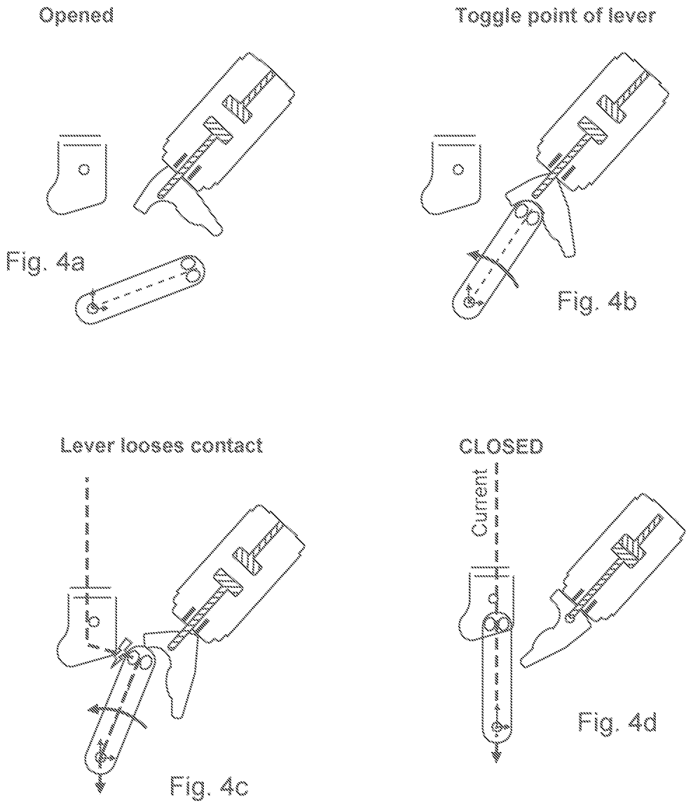

In FIGS. 2a and 2b it is shown, how the VI with the bi-stable L-shape lever is used in a load break switch as shunt VI. The L-shape lever is operated by the knife of the main current path of the load break switch. The current commutates during the breaking sequence from the main contact to the VI and is interrupted by the VI during the opening of the contacts, as shown in FIG. 3e. FIGS. 4a, 4b, 4c, and 4d demonstrate a closing sequence of the load break switch. Although the lever is moved by the knife of the main switch, due to the inertia of the contact system, the contacts of the VI are closing after the main contacts have completed the making sequence.

Returning to FIGS. 2a and 2b, the vacuum interrupter and lever of the load break switch are shown on the right and the main contact and knife of the load break switch are shown on the left, where the knife is at the bottom and can rotate about a pivot point that is itself located towards the bottom of the knife.

Returning to FIGS. 3a-3e, in the closed position the knife is in contact with the main contact and current can flow through the main contact and knife, and the switch is considered to be in its closed configuration as described above. The knife then starts to rotate and at some rotation point it is in contact with the main contact and the lever of the circuit breaker, constituting a commutation point, where a current path is provided from the main contact to the knife directly and through the circuit breaker because the contacts of the vacuum interrupter are closed. The switch is considered to be in its commutation configuration as described above. The knife keeps rotating and breaks contact with the main contact but is in contact with the lever and the contacts of the vacuum interrupter are still in contact with one another, such that current flow is only from the main contact to the circuit breaker, through the circuit breaker to the knife. The switch is considered to be in its transition point configuration as described above. The knife then keeps rotating and in doing so the lever is also continued to be rotated and at its toggle point the lever is at its third rotational orientation and the switch is in its toggle point configuration, after which it then does not need to be forced to keep rotating, but the contacts of the vacuum interrupter have been opened to break the current flow. Finally the lever has been placed in its second orientation, and the switch is in its opened configuration, where this is shown with the knife spaced from both the main contact and the lever (as shown in FIG. 3e), but it can be in contact with the lever but it is preferable that it is spaced from the lever.

As shown in FIGS. 4a-4d, the switch can then transition from the opened configuration to the closed configuration, through rotation of the knife in the opposite direction and a current path is made between the main contact and the knife and the vacuum interrupter is placed back in the state where the contacts are closed, and no current has passed through the circuit breaker. The switch is then ready for another load break switch operation as described above.

While the invention has been illustrated and described in detail in the drawing and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In an example, the shaft of the moveable contact is linked to the lever such that a movement of the rotation point of the lever in the direction parallel to the axis of the vacuum interrupter results in an equivalent movement of the moveable contact along the axis of the vacuum interrupter.

Thus, the lever is configured and shaped such that as it rotates a part of the lever that contacts the housing of the vacuum interrupter as it rotates is further from the rotation point than other counterparts of the lever. In this manner, the pivot point around which the lever is rotating actually moves away from the vacuum interrupter and as the shaft of the movable contact is linked to the lever the movable contact moves as the pivot of the lever point moves due to rotation of the lever. Thus a completely new lever driven system is provided, that at endpoints of the rotational movement stable positions can be provided.

In an example, the switch is configured such that in the closed configuration the first rotational orientation of the lever is a stable position.

In other words, the switch is configured such that an active forced movement of the lever is required to move the lever away from the first rotational orientation and as such the close configuration of the switch is a stable configuration. In use the vacuum interrupter has an evacuated internal volume, and as such the outer pressure pushes the lever towards the vacuum interrupter. In both this situation, the lever itself has an outer profile such that any significant rotational movement of the lever requires a force, because the lever itself as it rotates as a center of rotation is moved away from the vacuum interrupter. This provides for the stable position.

In an example, the switch is configured such that in the opened configuration the second rotational orientation of the lever is a stable position.

The stable position of the switch in the open configuration with the lever is in the second rotational orientation, is provided in a similar manner as for the stable position of the switch in the closed configuration as discussed above.

In an example, rotation of the knife about its pivot point in the first rotational direction transitions the switch from the commutation configuration to a toggle point configuration. In the toggle point configuration the knife is spaced from the main contact and in contact with the lever. In the toggle point configuration the lever is in a third rotational orientation and the rotation point of the lever is at a third distance from the fixed contact measured in the direction parallel to the axis of the vacuum interrupter that is greater than the second distance and the moveable contact is spaced from the fixed contact.

In an example, a first force applied to a first part of the lever by the knife transitions the switch from the closed configuration to the toggle point configuration.

In an example, the switch is configured such that no force is required to be applied to the first part of the lever to transition the switch from the toggle point configuration to the opened configuration.

Thus, after passing the toggle point, where the pivot point of the lever can be at its maximum displacement, the lever can continue to rotate to its final stable open position. This can be driven by the pressure differential between the inside and outside of the vacuum interrupter. In other words, an active force is required to be applied to a part of the lever to rotate the lever and in doing so move the pivot point of the lever away from the vacuum interrupter. This active force required to rotate the lever is required in part because the lever itself is in effect being pushed towards the vacuum interrupter by another pushing force. However, as a toggle point, where the pivot point of the lever is at its furthest point away from the vacuum interrupter, is just passed then the pushing force is pushing the lever towards vacuum interrupter will affectively push the pivot point towards the vacuum interrupter and the outer profile of the lever is shaped such that as the pivot point is moved towards vacuum interrupter the lever itself rotates. Thus, the active force that was required to rotate the lever to the toggle point is not then required with respect to further onward rotation of the lever.

In an example, rotation of the knife about its pivot point in the first rotational direction transitions the switch from the commutation configuration to a transition point configuration. In the transition point configuration the knife is spaced from the main contact and in contact with the lever. In the transition point configuration the moveable contact is in contact with the fixed contact, and current can flow through the main contact and through the vacuum interrupter to the knife.

In this way, current still flows, but now it only flows through the vacuum interrupter in going from the main contact to the knife. The vacuum interrupter can then open, driven by the lever, to provide a new and effective load break switch.

In an example, rotation of the knife about its pivot point in a second rotational direction opposite to the first rotational direction transitions the switch from the opened configuration to the closed configuration.

Thus, the lever can be used to in effect reset the load break switch without current having flowed through the vacuum interrupter.

In an example, rotation of the knife about its pivot point in the second rotational direction transitions the switch from the opened configuration to the toggle point configuration.

In an example, a second force applied to a second part of the lever is configured to transition the lever from the opened configuration to the closed configuration.

In an example, the switch is configured such that no force is required to be applied to the second part of the lever to transition the switch from the toggle point configuration to the closed configuration.

In a similar manner to that explained above respect to the lever continuing to rotate in the first rotational direction having just passed the toggle point, the lever is shaped such that when the lever is rotating in the second rotational direction, again when having just passed the toggle point the pivot point of the lever is pushed towards the vacuum interrupter and in doing so the lever continues to rotate without any force being required to be applied to the lever.

Thus, after passing the toggle point, where the pivot point of the lever can be at its maximum displacement, the lever can continue to rotate to its final stable closed start position. This is driven by the pressure differential between the inside and outside of the vacuum interrupter. A spring can be utilized to support a defined position to mitigate for design tolerances etc.

In an example, the switch comprises a spring configured to push the lever in the direction parallel to the axis of the vacuum interrupter toward the fixed contact.

In a second aspect, there is provided a medium voltage switchgear comprising a load break switch according to the first aspect.

Thus, the new type of load break switch with a vacuum interrupter has a new knife and lever driven closing system, to provide load current interruption in a completely new manner. The manner is provided where movement of the knife leads to current commutation from the main current path to and through the vacuum interrupter, and then further movement of the knife leads to the current being interrupted by the opening of the vacuum interrupter. All of this functionality is provided through interaction of the rotating knife with the lever that is coupled to the vacuum interrupter and where the knife also interacts with a main contact of the load break switch.

The above aspects and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A medium voltage load break switch, comprising:
a main contact;
a knife, wherein the knife is configured to rotate about a pivot point to connect to and be in contact with the main contact and to rotate about the pivot point to disconnect from and be spaced from the main contact;
a vacuum interrupter, wherein a fixed contact and a moveable contact are in a housing of the vacuum interrupter, and wherein the main contact is in electrical connection with the fixed contact; and
a lever, wherein the lever is configured to rotate about a rotation point of the lever, and wherein the main contact is spaced from the lever;
wherein a shaft of the moveable contact is aligned along an axis of the vacuum interrupter, and wherein the shaft of the moveable contact is linked to the lever;
wherein in a closed configuration, the knife is in contact with the main contact and spaced from the lever, wherein the lever is at a first rotational orientation and the rotation point of the lever is at a first distance from the fixed contact measured in a direction parallel to the axis of the vacuum interrupter and the moveable contact is in contact with the fixed contact, and wherein current can flow through the main contact directly to the knife;
wherein rotation of the knife about its pivot point in a first rotational direction transitions the switch from the closed configuration to a commutation configuration, wherein in the commutation configuration the knife is in contact with the lever and in contact with the main contact, and wherein current can flow through the main contact directly to the knife and flow through the main contact and through the vacuum interrupter to the knife; and
wherein rotation of the knife about its pivot point in the first rotational direction transitions the switch from the commutation configuration to an opened configuration, wherein in the opened configuration the knife is spaced from the main contact and spaced from the lever or in contact with the lever, and wherein the lever is in a second rotational orientation and the rotation point of the lever is at a second distance from the fixed contact measured in the direction parallel to the axis of the vacuum interrupter that is greater than the first distance and the moveable contact is spaced from the fixed contact.

2. The switch according to claim 1, wherein the shaft of the moveable contact is linked to the lever such that a movement of the rotation point of the lever in the direction parallel to the axis of the vacuum interrupter results in an equivalent movement of the moveable contact along the axis of the vacuum interrupter.

3. The switch according to claim 1, wherein the switch is configured such that in the closed configuration the first rotational orientation of the lever is a stable position.

4. The switch according to claim 1, wherein the switch is configured such that in the opened configuration the second rotational orientation of the lever is a stable position.

5. The switch according to claim 1, wherein rotation of the knife about its pivot point in the first rotational direction transitions the switch from the commutation configuration to a toggle point configuration, wherein in the toggle point configuration the knife is spaced from the main contact and in contact with the lever, and wherein the lever is in a third rotational orientation and the rotation point of the lever is at a third distance from the fixed contact measured in the direction parallel to the axis of the vacuum interrupter that is greater than the second distance and the moveable contact is spaced from the fixed contact.

6. The switch according to claim 5, wherein a first force applied to a first part of the lever by the knife transitions the switch from the closed configuration to the toggle point configuration.

7. The switch according to claim 6, wherein the switch is configured such that no force is required to be applied to the first part of the lever to transition the switch from the toggle point configuration to the opened configuration.

8. The switch according to claim 1, wherein rotation of the knife about its pivot point in the first rotational direction transitions the switch from the commutation configuration to a transition point configuration, wherein in the transition point configuration the knife is spaced from the main contact and in contact with the lever, and the moveable contact is in contact with the fixed contact, and wherein current can flow through the main contact and through the vacuum interrupter to the knife.

9. The switch according to claim 1, wherein rotation of the knife about its pivot point in a second rotational direction opposite to the first rotational direction transitions the switch from the opened configuration to the closed configuration.

10. The switch according to claim 9, wherein rotation of the knife about its pivot point in the first rotational direction transitions the switch from the commutation configuration to a toggle point configuration, wherein in the toggle point configuration the knife is spaced from the main contact and in contact with the lever, and wherein the lever is in a third rotational orientation and the rotation point of the lever is at a third distance from the fixed contact measured in the direction parallel to the axis of the vacuum interrupter that is greater than the second distance and the moveable contact is spaced from the fixed contact, and wherein rotation of the knife about its pivot point in the second rotational direction transitions the switch from the opened configuration to the toggle point configuration.

11. The switch according to claim 10, wherein a second force applied to a second part of the lever is configured to transition the lever from the opened configuration to the toggle point configuration.

12. The switch according to claim 11, wherein the switch is configured such that no force is required to be applied to the second part of the lever to transition the switch from the toggle point configuration to the closed configuration.

13. The switch according to claim 1, wherein the switch comprises a spring configured to push the lever in the direction parallel to the axis of the vacuum interrupter toward the fixed contact.
